(19) United States
(12) Patent Application Publication
(10) Pub. No.: US 2025/0147192 A1
(43) Pub. Date: May 8, 2025

(54) METHOD AND SYSTEM FOR SEAMLESS TRACKING OF AN ASSET ACROSS INDOOR AND OUTDOOR ENVIRONMENTS

(71) Applicant: LTI Mindtree Ltd, Mumbai (IN)

(72) Inventors: Sathish Pandiyan J, Mumbai (IN); Ramachandran Essakiraj, Mumbai (IN); Krishsankar Devarajan, Mumbai (IN); Elangovan E, Mumbai (IN); Angeline Christy Mohan Kumar, Mumbai (IN); Pari Y, Mumbai (IN); Gajavelli Sharath Kumar, Mumbai (IN)

(21) Appl. No.: 18/768,172

(22) Filed: Jul. 10, 2024

(30) Foreign Application Priority Data
Nov. 8, 2023 (IN) 202321076348

(51) Int. Cl. G01S 19/48

(52) U.S. Cl. CPC G01S 19/48

(57) ABSTRACT

The disclosure provides a method and system for seamless tracking of an asset across indoor and outdoor environments by utilizing tags affixed on assets and anchor nodes deployed across a facility. Each anchor node emits heartbeat signals that are received by neighboring anchor nodes that comprise information pertaining to coordinates and timestamp of anchor nodes. A data acquisition module receives processed data from each tag to listen to heartbeat signals being shared. A tracking module determines live positional information of the asset based on data retrieved from the data acquisition module. The tracking module, by utilizing predictive positioning algorithms, detects an indoor location of each tag affixed on the asset using a UWB chipset and detects an outdoor location of each tag affixed on an asset using a GNSS chipset.

### CROSS-REFERENCE TO PRIOR APPLICATION

This application claims the benefit of and priority to Indian Patent Application No. 202321076348, filed on Nov. 8, 2023, which is hereby incorporated herein by reference in its entirety.

The entire contents of the priority application, including any appendices, exhibits, and amendments filed therewith, are hereby incorporated by reference in its entirety.

### FIELD

Various embodiments of the present disclosure generally relate to tracking of an asset. More particularly, the disclosure relates to a method and system for seamless tracking of an asset across indoor and outdoor environments using a plurality of tags and a plurality of anchor nodes deployed across a facility.

### BACKGROUND

Current asset tracking solutions available in the market primarily focus on indoor or outdoor tracking separately using different technologies. Indoor asset tracking solutions rely on technologies such as Wi-Fi, Bluetooth, and Ultrawide Band for tracking assets. Outdoor asset tracking solutions utilize Global Navigation Satellite System (GNSS) trackers for tracking assets. However, the existing solutions fail to provide an efficient unified system that seamlessly transitions between indoor & outdoor tracking. This is because the principles of measuring and monitoring indoor and outdoor environments are fundamentally different. Developing a solution for the seamless of these environments necessitates additional hardware costs, infrastructure costs, and ongoing maintenance expenses.

Though some of the existing solutions refer to a unified method for tracking both outdoor and outdoor positioning of assets, the setup mandates installation of a plurality of base stations on respective outdoor locations in an outdoor area, where the base stations are configured to use a predetermined communication link for indoor positioning at indoor locations. These solutions are designed to perform outdoor positioning of the assets in the outdoor area using the determined precise position of each of the plurality of base stations in a same manner as the indoor positioning. These setups include installation of base stations that are huge in structure, resulting in incurring huge costs and maintenance effort.

In certain scenarios, assets that need to be tracked may be equipped with multiple positioning mechanisms (or position determination schemes) to calculate their locations. For instance, assets can employ satellite positioning systems (SPS) like the Global Positioning System (GPS), terrestrial cellular stations, hybrids of GPS and terrestrial cellular, radio frequency (RF) fingerprinting, Wi-Fi positioning, forward link trilateration (FLT), advanced FLT (AFLT), and so forth. Some of these position determination schemes are more suited to outdoor environments (e.g., SPS, GPS), while others are better for indoor use (e.g., Wi-Fi positioning). However, effectively transitioning between these position determination schemes during shifts between indoor and outdoor spaces can be challenging. One option is to maintain both GPS and Wi-Fi position determination schemes active at all times, ensuring that at least one suitable scheme is available when transitioning. Nevertheless, maintaining both schemes continuously can have a negative impact on the asset's battery life.

In addition to the infrastructure specific challenges, there are unaddressed issues related to communication between movable tags and fixed anchor nodes. Though the existing solutions disclose the concept of allowing communication between movable tags and fixed anchors, they do not offer effective working conditions, as the communication between fixed anchor nodes gets disrupted when the anchor nodes communicate periodically with the movable tags updating their location information.

Therefore, there exists a need for a method and system that can address the aforementioned challenges using a mechanism to seamlessly track an asset in both indoor and outdoor environments through the integration of a UWB (Ultrawide Band) chip and GNSS (Global Navigation Satellite System) chipset into a singular hardware, providing an all-in-one solution for indoor and outdoor tracking environments.

### SUMMARY

The present disclosure discloses a method and system for seamless tracking of an asset across indoor and outdoor environments. The method and system tracks an asset in real-time by utilizing a plurality of tags and a plurality of anchor nodes, wherein each tag of the plurality of tags is affixed on an asset to be tracked and the plurality of anchor nodes are deployed across a facility. Each of the plurality of anchor nodes is configured to emit heartbeat signals, wherein the heartbeat signals from an anchor node are received by neighboring anchor nodes, the heartbeat signals comprising information pertaining to the coordinates of the respective anchor nodes. The method and system comprises a data acquisition module configured to receive processed data from at least one of the plurality of tags, wherein each tag is configured to listen to heartbeat signals being shared between the plurality of anchor nodes. A tracking module is configured to determine live positional information of the asset based on data retrieved from the data acquisition module, wherein the tracking module detects an indoor location of a tag affixed on an asset using a UWB chipset and detects an outdoor location of a tag affixed on an asset using a GNSS chipset. The tracking module detects indoor and outdoor location of the tag by utilizing one or more predictive positioning algorithms.

Further, each tag of the plurality of tags is configured to process heartbeat signals to derive the coordinates based on data received from the plurality of anchor nodes. A power management module of the system is configured to constantly monitor and manage the power levels of the plurality of tags and the plurality of anchor nodes.

One or more advantages of the prior art are overcome, and additional advantages are provided through the disclosure. Additional features are realized through the technique of the disclosure. Other embodiments and aspects of the disclosure are described in detail herein and are considered a part of the disclosure.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the disclosure.

FIG. 1 is a diagram that illustrates an environment in which various embodiments of the disclosure may function.

FIG. 2 is a diagram that illustrates a system for seamlessly tracking an asset across indoor and outdoor environments.

FIG. 3 is a diagram that illustrates an exemplary scenario of tracking an asset in an indoor environment, in accordance with an embodiment of the disclosure.

FIG. 4 is a diagram that illustrates an exemplary scenario of tracking an asset in an outdoor environment, in accordance with an embodiment of the disclosure.

FIG. 5 is a flow chart illustrating a method for seamlessly tracking an asset across indoor and outdoor environments, in accordance with an embodiment of the disclosure.

### DETAILED DESCRIPTION

Before describing in detail embodiments that are in accordance with the present disclosure, it should be observed that the embodiments reside primarily in combination of method steps and components related to a method and system for seamless tracking of an asset across indoor and outdoor environments using a plurality of tags and a plurality of anchor nodes. Accordingly, the system components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Systems for seamless tracking of an asset across indoor and outdoor environments, methods for seamless tracking of an asset across indoor and outdoor environments, are disclosed herein. The systems, and methods disclosed herein seamlessly tracks real-time location of an asset, affixed with a tag, across indoor and outdoor environments by switching between the UWB chipset and the GNSS chipset of the tag. The present disclosure is a geospatial solution specifically designed for real-time seamless tracking of fleet vehicles, high value assets, etc., offering end to end digitized workflow with customized dashboards and reports. Primarily, the present disclosure address the common challenge of achieving complete visibility for assets, people, and inventory in both enclosed and open-to-sky environments, a scenario prevalent across various industry verticals.

The UWB refers to a short-range, wireless communication protocol that operates through radio waves and can be used to capture highly accurate spatial and directional data. UWB also refers to a wireless communication technology that utilizes a broad spectrum of frequencies, spanning across a wide range. Typically, UWB devices transmit information using very short duration, low-energy pulses spread across this wide frequency range.

The GNSS refers to a network of satellites that can determine the location and/or altitude of an asset. The network of satellites of the GNSS system broadcasts GNSS signals. A GNSS receiver can receive the GNSS signals via an antenna and calculate the location of the receiver, the time of signal reception, and/or the altitude of the receiver. Location is determined by receiving GNSS satellite signals from multiple satellites in known positions, determining the transition time for each of the signals, and solving for the position of the receiving antenna based on the known data.

In some non-limiting embodiments, the assets can be one or more types such as, for example, a fleet vehicle, an employee, an inventory, an equipment, parcels, packages, subjects, machines, tools, vehicles, etc.

A Geo Real-time location system (RTLS) encompasses several automated identifications (auto-ID) technologies that use wireless signals to determine the precise location of tagged assets or personnel. At its core, Geo RTLS employs a combination of hardware, software and communication technologies to determine and relay the real-time location of tagged items or people within a defined area of interest.

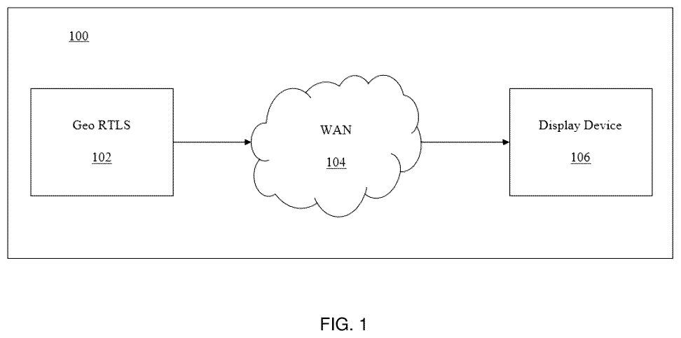

FIG. 1 is a diagram that illustrates an environment 100 in which various embodiments of the disclosure may function. Referring to FIG. 1, the environment 100 comprises a Geo Real-time location system (RTLS) 102, a WAN 104, and a display device 106.

Computer readable instructions are typically loaded onto the Geo Real-time location system (RTLS) 102 to cause a series of operations to be performed by a processor of the Geo Real-time location system (RTLS) 102 and thereby effect the method, specified in flowcharts and/or narrative descriptions of computer-implemented methods included in the document (collectively referred to as “the inventive methods). These computer readable program instructions are stored in various types of computer readable storage media, such as cache, for example. The program instructions, and associated data, are accessed by, for example. The program instructions, and associated data, are accessed by, and executed by, the processor to control and direct performance of the inventive methods.

The Geo RTLS 102 is a geospatial solution specifically designed for achieving real-time seamless indoor and outdoor tracking of fleet vehicles, high-value assets, employees, and more. It offers a comprehensive, end-to-end digitized workflow with customized dashboards and reports. The Geo RTLS 102 is specifically tailored to address the challenge of ensuring complete visibility for assets, people, and inventory in a variety of environments, encompassing both enclosed and open-to-sky settings. These scenarios are common in diverse verticals such as Architecture, Engineering, Construction (AEC), Logistics and Supply Chain Management, Utility, Manufacturing, Healthcare, Retail, Aviation, Mining, and Smart Buildings/Cities, among others.

The Geo RTLS 102 uses a combination of fixed anchors and movable tags along with advanced positioning algorithms such as multi-lateration, and dead reckoning to accurately compute the position of a tag mounted onto an asset, a vehicle, an equipment, or a person in both indoor and outdoor environments.

Within the Geo RTLS 102, there exists a digital twin of the geographical areas, equipped with relevant feature metrics. It incorporates a UWB and GNSS chipset for indoor positioning and a GPS chipset for outdoor positioning. The Geo RTLS 102 allows for a seamless transition between indoor and outdoor environments through spatial algorithms and chipset-level programming.

In an embodiment, the Geo RTLS 102 offers a wide array of valuable features such as real-time and accurate tracking, history playback of asset and employee movements, real-time indoor and outdoor inventory management, productivity assessment based on customer-specific KPIs, analytics and insights on resource and space utilization to identify bottlenecks and enhance efficiency, as well as real-time alerts to improve operational safety and safeguard assets and employees from potential threats and dangers.

The Geo RTLS 102 communicates with the display device 106 via the WAN 104, to display the locations of the asset across indoor and outdoor environments. The WAN 104 of the environment 100 is a wide area network, such as the internet, capable of communicating computer data over long distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

In some embodiments, the WAN 104 of the environment 100 may utilize clustered computing and components acting as a single pool of seamless resources when accessed through the WAN 104 by one or more computing systems. For example, such embodiments can be used in a data center, cloud computing network, storage area network (SAN), and network-attached storage (NAS) applications.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service.

A cloud computing environment is service-oriented, focusing on statelessness, low coupling, modularity, and semantic interoperability. At the heart of cloud computing is an infrastructure that includes a network of interconnected nodes.

In some non-limiting embodiments, the cloud computing environment includes a cloud network comprising one or more cloud computing nodes with which cloud consumers may use the end-user device(s) or client devices to access one or more software products, services, applications, and/or workloads provided by cloud service providers or tenants of the cloud network. Examples of the user device are depicted and may include devices such as a desktop computer, laptop computer, smartphone, or cellular telephone, tablet computers, and smart devices such as a smartwatch or smart glasses. Nodes may communicate with one another and may be grouped (not shown) physically or virtually in one or more networks, such as Private, Community, Public, or Hybrid clouds as described hereinabove, or a combination thereof. This allows the cloud computing environment to offer infrastructure, platforms, and/or software as services for which a cloud consumer does not need to maintain resources on a local computing device.

Public Cloud is any computer system available for use by multiple entities that provides on-demand availability of computer system resources and/or other computer capabilities, especially data storage (cloud storage) and computing power, without direct active management by the user.

Private Cloud is similar to the public cloud, except that the computing resources are only available for use by a single enterprise. While the private cloud is depicted as being in communication with WAN, in other embodiments, a private cloud may be disconnected from the internet entirely and only accessible through a local/private network.

A hybrid cloud is composed of multiple clouds of different types (for example, private, community, or public cloud types), often implemented by different vendors. Each of the multiple clouds remains a separate and discrete entity. Still, the larger hybrid cloud architecture is bound together by standardized or proprietary technology that enables orchestration, management, and/or data/application portability between the multiple constituent clouds.

The display device 106 may be implemented using any device capable of wireless communication, including but not limited to a cellular telephone, computer, server, router, laptop, tablet, wearable device, watch, appliance, automobile, or airplane. The display device 106 may be configured to (e.g., include hardware and/or firmware and software for) communicate using a particular protocol for a wireless communication signal (e.g., Bluetooth Low Energy, Bluetooth Smart, Wi-Fi, CDMA, TDMA).

The display device 106 may receive transmitted signals from a remote server in real-time. The transmitted signal from the remote server is formatted in accordance with the wireless communication protocol expected by the display device 106. The transmitted signal can be a backscatter signal such as but not limited to, a Bluetooth signal (e.g., such as an advertising packet), a Wi-Fi signal (e.g., such as a beacon frame), and/or a ZigBee signal. For example, the backscatter signal may be an IEEE 802.15.4 beacon frame. In this manner, no additional software, firmware, or hardware may be required for the display device 106 to receive and decode the transmitted backscatter signal than is required for the display device 106 to receive and decode received signals from other sources that are formatted in accordance with the wireless communication protocol.

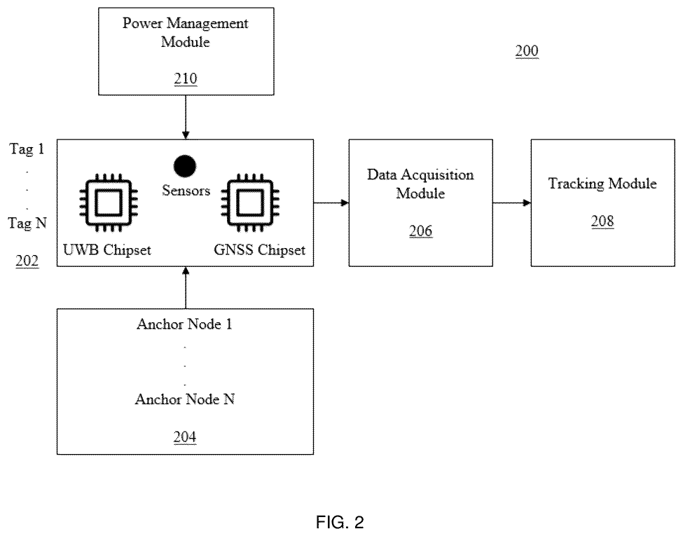

FIG. 2 is a diagram that illustrates a system 200 for seamlessly tracking an asset across indoor and outdoor environments in accordance with an embodiment of the disclosure. Referring to FIG. 2, the system 200 comprises tag 1 . . . tag N 202, anchor node 1 . . . anchor node N 204, a data acquisition module 206, a tracking module 208, and a power management module 210.

With reference to FIG. 2, a plurality of tags disclosed herein are depicted as tag 1 . . . tag N 202, and a plurality of nodes disclosed herein are depicted as anchor node 1 . . . anchor node N 204.

In accordance with the system 200, each tag of the tag 1 . . . tag N 202 is provided with a corresponding active unique ID upon registration with the system 200. Thereafter, a tag gets affixed to an asset that is required to be tracked as the asset travels through the indoor and outdoor environments.

Each tag of the tag 1 . . . tag N 202 is integrated with the UWB chipset, the GNSS chipset, and one or more sensors that enables tracking of each tag through the indoor and outdoor settings.

The UWB chipset of each tag may include one or more components such as, an antenna, a switch, an RF physical medium device (PMD), a digital PMD, a physical (PHY) layer conversion protocol (PLCP), a media access controller (MAC), a host controller, a MAC manager, a PHY layer manager, and an electronic device.

The RF PMD of the UWB chipset, may further include a receiver front end, a demodulator, a transmitter front end, and a modulator, while the digital PMD further includes a receiver baseband, a transmitter baseband, and a timing controller. The RF PMD may include an application layer that allows it to operate in connection with the host controller.

When the UWB chipset of each tag receives a signal, the antenna converts an incoming UWB electromagnetic waveform into an electrical signal (or optical signal) and provides this signal to the switch. In a receiving mode the switch is connected to the receiver front end in the RF PMD, which performs analog signal processing on the incoming signal. Depending on the type of waveform, the receiver front end processes the electrical (or optical) signals so that the level of the signal and spectral components of the signal are suitable for processing in the demodulator. This processing may include spectral shaping, such as a matched filtering, partially matched filtering, simple roll-off, etc.

The received signal is then passed from the receiver front end through the demodulator and the receiver baseband for signal processing to extract the information from the incoming signal. The demodulator performs analog signal processing on the incoming RF signal, which is then converted (preferably by either the demodulator or the receiver baseband) for digital processing by the receiver baseband.

The information extracted from the incoming signal is then sent from the receiver baseband to the PLCP to convert it to proper format for the MAC. Timing information from the incoming signal (or from a signal output from the demodulator) is received by the timing controller and is sent back to timing generators in the demodulator and the modulator.

The MAC serves as an interface between the UWB wireless communication functions implemented by both the RF PMD and the digital PMD and the application layer that uses the UWB communications channel for exchanging data with the device. The MAC is preferably a processor-based unit that is implemented either with hard-wired logic, such as in one or more application specific integrated circuits (ASICs) or in one or more programmable processors.

The host controller operates as an interface between the MAC and the device, and provides instructions to the RF PMD, the digital PMD, the PLCP and the MAC through the MAC manager and the PHY layer manager.

In some non-limiting embodiments, the GNSS chipset of each tag comprises a GNSS receiver and a processor. The GNSS receiver is capable of receiving signals from GNSS satellites, GLONASS satellites, or from a combination of satellites from different constellations.

The GNSS chipset can receive signals from a global and/or regional satellite network and employ various calculations on the received signals to determine a geographical location of the chipset and the asset to which each tag with the GNSS chipset is integrated. GNSS chipsets can receive signals that are broadcasted from various types of satellite networks, which in some cases can also include ground-based repeaters or transmitters that facilitate location detection by a GNSS device. These satellite networks can include but are not limited to, Global Position System (GPS), GLONASS, Galileo positioning system, and other types of location finding systems.

In an embodiment, each tag in which the GNSS chipset is integrated, employs a system-on-a-chip (SoC) GNSS chipset architecture. In such a solution, the entire GNSS system is integrated within a single chipset or module that is integrated in each tag of the tag 1 . . . tag N 202. In other words, a SoC GNSS chipset includes various hardware components that compute a requested location at a particular precision and update rate as requested by a host device in which the GNSS chipset is integrated. In one example, the output of such a GNSS solution is position, velocity, and time that is calculated by the SoC GNSS chipset from signal measurements associated with demodulated signals received from one or more satellites and/or ground-based signal transmitters. For example, an SoC chipset can include a radio frequency tuner(s), baseband processor(s), and one or more central processing units (CPUs) in which a position data point is calculated that expresses a location based upon the signals received in the RF tuner(s).

Each GNSS satellite orbiting the Earth may broadcast respective GNSS navigation data. For example, each GNSS satellite orbiting the Earth may broadcast a respective GNSS signal conveying a message containing the GNSS navigation data of the respective satellite (i.e., the navigation data are part of the message). Receiving GNSS navigation data may accordingly be understood to mean that the GNSS navigation data are received from a GNSS satellite or a spoofing device, for example by receiving a GNSS signal conveying a message containing the GNSS navigation data from the GNSS satellite or the spoofing device.

The GNSS navigation data received by each tag of tag 1 . . . tag N 202 may, for example, contain at least one of ephemeris data that enable determining an orbital position of a GNSS satellite (e.g. the GNSS satellite from which the GNSS navigation data have been received) at a given time (e.g. for a limited period of time), and clock data that enable determining a deviation of a clock of a GNSS satellite (e.g. the GNSS satellite from which the GNSS navigation data have been received) from a GNSS system time at a given time (e.g. for a limited period of time).

The sensors integrated with each tag of tag 1 . . . tag N 202 can be such as, but not limited to, a location sensor, an accelerometer, a gyroscope, a temperature sensor, and a light sensor. Usage of various sensors within the tag enhances the usage of hardware in other applications such as, for example, SOS calls, cold storage inventory, theft & tamper prevention etc.

Each tag of tag 1 . . . tag N 202 is also configured with a processor for performing computations on data received by the tag. The processor may comprise suitable logics, interfaces, and/or code that may be configured to execute the instructions stored in a memory to implement various functionalities of the system 200 in accordance with various aspects of the disclosure. The processor may be further configured to communicate with multiple modules of the system 200 via a communication fabric.

The memory may comprise suitable logic and/or interfaces that may be configured to store instructions (for example, the computer-readable code) that can implement various aspects of the present disclosure. In an embodiment, the memory includes random access memory (RAM). In general, the memory can include any suitable volatile or non-volatile computer-readable storage media.

The communication fabric comprises suitable logic, interfaces, and/or code that may be configured to transmit data between modules, engines, databases, memories, and other components of the Geo Real-time location system (RTLS) 102 comprising tag 1 . . . tag N 202, anchor node 1 . . . anchor node N 204, the data acquisition module 206, the tracking module 208, and the power management module 210 for use in performing functions discussed herein.

Each anchor node of the anchor node 1 . . . anchor node N 204 is installed in respective locations across an indoor environment, for instance, ceilings, walls, and the likes of an indoor environment. The fixed position of each anchor node is precisely measured at the time of installation so as to determine at least relative positional relationships among the anchor node 1 . . . anchor node N 204. The measured relative positional information obtained from of the anchor node 1 . . . anchor node N 204 may be mapped onto a diagram or 3D plan view of the indoor environment so as to associate with corresponding actual physical locations.

In some non-limiting embodiments, the 3D plan view of the indoor environment refers to a comprehensive and visually engaging representation of the spatial layout within a building or a facility. This view combines the benefit of both 2D floor plans and 3D models, providing a top-down view enriched with depth and dimension. The 3D plan view of the indoor environment facilitates a holistic perspective, ensuring that every aspect of the space is thoughtfully considered and well-organized.

Accordingly, the 3D plan view of the indoor environment provides a powerful and efficient solution for managing and constantly monitoring assets in a complex environment. By granting 3D view of the facility, it grants a bird's eye-view that includes both spatial layout and elevation details. This 3D perspective disclosed in the disclosure enhances asset placement, storage, and movement logistics, ensuring that the assets are efficiently tracked and utilized. The 3D plan view of the indoor environment help in swiftly identifying the exact location of the assets and their status, enabling better decision-making.

In an embodiment, the anchor node 1 . . . anchor node N 204 are permanently installed in respective locations across the indoor environment. In another embodiment, the anchor node 1 . . . anchor node N 204 may be detachably installed in respective locations across the indoor environment.

Each anchor node of anchor node 1 . . . anchor node N 204 is configured to emit heartbeat signals. The heartbeat signals include information pertaining to location coordinates (x, y, z) of the anchor node 1 . . . anchor node N 204 along with timestamp information. Each anchor node is also configured to receive the heartbeat signals emitted by neighboring anchor nodes.

In some non-limiting embodiments, the heartbeat signals refer to periodic signals or messages sent between devices or systems to indicate their operational status. Location coordinates of the anchor node 1 . . . anchor node N can be in the form of latitude and longitude, providing the exact geographical position of the device or object. This data is essential for tracking the location of the asset.

Timestamp information refers to the time when the heartbeat signals are generated. It provides information about the time at which the tag's location was recorded, helping in tracking the tag and in turn tracking the asset's movement over time.

Combining location coordinates and timestamp in heartbeat signals allows real-time tracking, monitoring and historical analysis of the asset's movements and status.

In accordance with an embodiment, each tag of the tag 1 . . . tag N 202 is also configured to listen to the heartbeat signals emitted by various anchor nodes as each tag traverses through the indoor environment. Each tag is configured to process the heartbeat signals to derive relevant information about the positions of the anchor node 1 . . . anchor node N 204 in the vicinity of the tag.

The data acquisition module 206 is configured to receive processed data from each tag. The data acquisition module 206 stores the received processed data in a storage device that can include any suitable volatile or non-volatile storage media. The storage device may be configured to store instructions (for example, the computer-readable program code) that can implement various aspects of the present disclosure.

The tracking module 208 is configured to determine live positional information of the asset based on data retrieved from the data acquisition module 206. The tracking module 208 detects an indoor location of each tag of the tag 1 . . . tag N 202 affixed on the asset using the UWB chipset and detects an outdoor location of a tag affixed on an asset using the GNSS chipset.

The tracking module 208 detects indoor and outdoor location of each tag by utilizing predictive positioning algorithms. For instance, the predictive positioning algorithms are mathematical or computational methods used to predict the position of the asset based on historical data, current position, and other relevant factors. These algorithms often utilize techniques like extrapolation, machine learning, or statistical analysis to estimate positions, making them valuable in various fields.

In some non-limiting embodiments, the predictive positioning algorithms are used to estimate or forecast future positioning and location of an asset based on historical data, real-time data, and predictive modelling. The predictive algorithms used by the tracking module 208 can be such as, for example, Kalman Filer algorithms, Particle Filter algorithm, Hidden Markov Models (HMM), Recurrent Neural Networks (RNNs), Long Short-Memory (LSTM) Networks, Markov Models etc.

In an instance, each anchor node of the anchor node 1 . . . anchor node N 204 transmits random heartbeat signals and all the other neighboring anchor nodes and tags around the anchor node receives the transmitted heartbeat signals. The heartbeat signals contain timestamp of each anchor node, and its neighboring anchor nodes which receive these heartbeat signals respond back with a message containing respective timestamps. Accordingly, the tag 1 . . . tag N 202 that are in the range of anchor node 1 . . . anchor node N 204 receives time stamps and anchors' location (x, y, z) coordinates. Accordingly, each tag of the tag 1 . . . tag N 202 computes difference in distance between a pair of anchor nodes and then forms a hyperbola between the anchor node 1 . . . anchor node N 204 and its own position. Further, based on two or more pairs of hyperbola, each tag computes its intersection point to know its location.

The tracking module 208 thus determines live positional information of the asset based on data retrieved from the data acquisition module 206 that in turn receives information from each tag of the tag 1 . . . tag N 202.

In an embodiment, the tracking module 208 includes a GPS data processing unit to process GPS data received from each tag when the asset is in an outdoor environment. The tracking module 208 also includes an integration unit to seamlessly integrate positional data derived from UWB and GPS for continuous tracking of the asset across indoor and outdoor environments.

In some non-limiting embodiments, the GPS data processing unit can be referred to as a specialized electronic device designed to receive, process, and interpret signals from GPS satellites. The GPS data processing unit calculates precise position, velocity, and time information for a given location. The GPS data processing unit plays a crucial role in various applications, including navigation, transportation, surveying, mapping and the like.

When a GPS receiver receives signals from multiple satellites, it uses trilateration techniques to calculate its three-dimensional position. The unit processes the signals, determines the time it takes for each signal to travel from the satellite to the receiver, and uses this information to calculate the distance between the receiver and each satellite. By combining these distance measurements, the GPS data processing unit can compute the receiver's precise position in terms of latitude, longitude, and altitude.

The tracking module 208 also includes a map interface module configured to visualize the positional information of the asset on a facility map. The map interface module acts as a bridge between the GPS data processing unit and the visual representation of assets within a facility or a geographical area. It takes the precise position data calculated by the GPS processing unit and translates it into a format that can be displayed on a digital map or floor plan of the facility.

The primary objective of the map interface module is to provide a real-time, intuitive visualization of the asset's position within the facility. It overlays the asset's position, represented by markers or icons, onto the facility map. This allows operators, managers, or stakeholders to easily track the asset's movement and location relative to the layout of the facility. The integration of visual cues, such as color coding or directional arrows, can enhance the comprehensibility of the asset's movement and status.

Furthermore, the map interface module often offers interactive features, enabling users to zoom, plan and customize the display to focus on specific areas of interest. Additionally, it may offer filtering options to display multiple assets simultaneously and allow for easy differentiation between different types of assets based on their position, status, or attributes. Overall, the map interface module plays a pivotal role in enhancing operational efficiency, safety, and decision-making with the facility by presenting a clear and visual representation of the asset positions and their movements.

The power management module 210 is configured to monitor and manage the power levels of the tag 1 . . . tag N, and the anchor node 1 . . . anchor node N. The power management module 210 plays a significant role in optimizing the energy efficiency and functionality of components integrated with each tag. The power management module 210 is seamlessly integrated with each tag that is associated with the asset. By effectively managing power, the power management module 210 ensures that the components operate at peak performance while conserving energy resources.

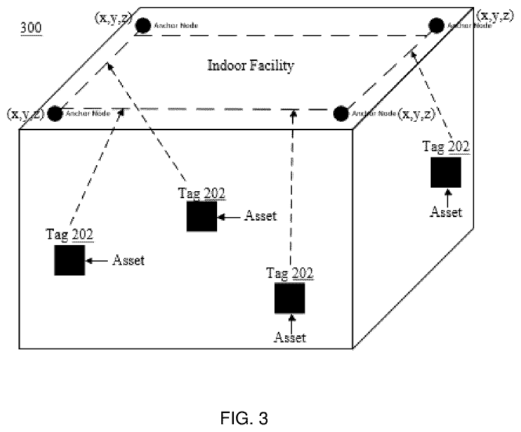

FIG. 3 is a diagram that illustrates an exemplary scenario of tracking an asset in an indoor environment 300, in accordance with an embodiment of the disclosure. The indoor environment 300 referred to in FIG. 3 can include a warehouse, a production plant, a manufacturing plant, etc.

In accordance with the exemplary embodiment, each tag of the tag 1 . . . tag N 202 associated with one or more assets in the indoor environment constantly listen to the heartbeat signals transmitted between the one or more anchor nodes arranged in a fixed position in the indoor environment. The heartbeat signals transmitted between the anchor node 1 . . . anchor node N 204 include details of positional coordinates of each anchor node.

The heartbeat signals received by each tag of the tag 1 . . . tag N 202 are sent to the data acquisition module 206 in real-time for further processing. The data acquisition module 206 processes the heartbeat signals to derive the coordinates based on data received from the anchor node 1 . . . anchor node N.

The tracking module 208 then determines live positional information of the asset based on data retrieved from the data acquisition module 206. The tracking module 208 detects an indoor location of each tag of the tag 1 . . . tag N 202 affixed on the asset using the UWB chipset.

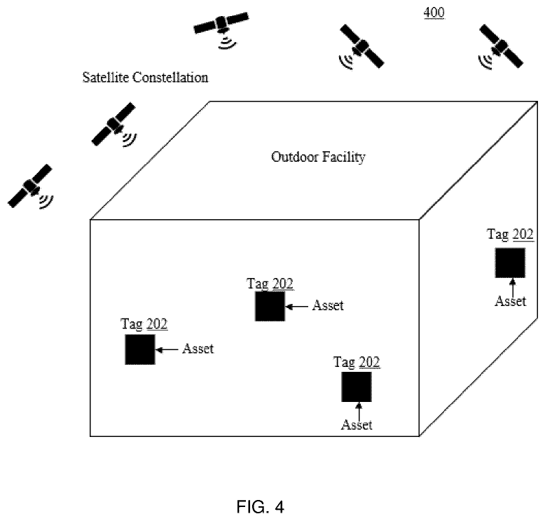

FIG. 4 is a diagram that illustrates an exemplary scenario of tracking an asset in an outdoor facility 400, in accordance with an embodiment of the disclosure. The outdoor facility 400 referred to in FIG. 4 can include a vehicle parking facility, an open ground facility, etc.

In accordance with the exemplary embodiment, the one or more tags associated with one or more assets in the outdoor environment constantly receive positional information from the group of satellites.

The positional information received by each tag of the tag 1 . . . tag N 202is sent to the data acquisition module 206 in real-time for further processing. The data acquisition module 206 processes the positional information to derive the coordinates based on data received from each tag of the tag 1 . . . tag N 202 associated with the assets.

The tracking module 208 then determines live positional information of the assets in the outdoor environment based on data retrieved from the data acquisition module 206. The tracking module 208 detects an outdoor location of the tag affixed on an asset using a GNSS chipset.

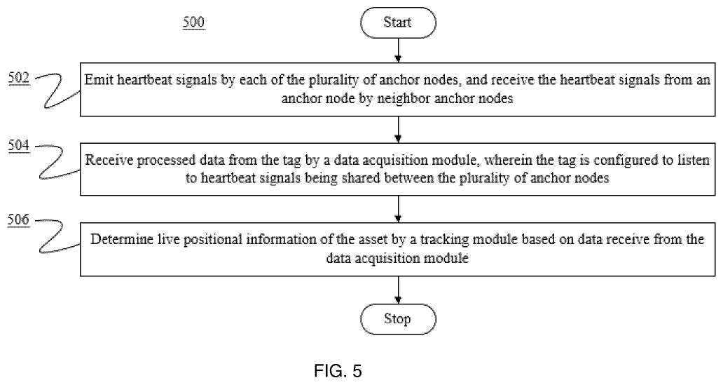

FIG. 5 is a flow chart 500 illustrating a method for seamlessly tracking an asset across indoor and outdoor environments, in accordance with an embodiment of the disclosure. Referring to FIG. 5, the method seamlessly tracks an asset across indoor and outdoor environments. The asset is fixed with a tag of the tag 1 . . . tag N 202and anchor node 1 . . . anchor node N 204 are deployed across the indoor environment.

At step 502, each anchor node of the anchor node 1 . . . anchor node N 204 emits heartbeat signals, wherein the heartbeat signals from the anchor node are received by neighboring anchor nodes, the heartbeat signals comprising information pertaining to coordinates of the respective anchor nodes.

Each anchor node of the anchor node 1 . . . anchor node N 204 is installed in respective locations across an indoor environment. Examples of respective locations across the indoor environment can be such as, ceilings, walls, and the like of an indoor environment. The heartbeat signals from the anchor node are received by neighboring anchor nodes. The heartbeat signals include information pertaining to coordinates (x, y, z) of each anchor node of the anchor node 1 . . . anchor node N 204.

The fixed position of each anchor node is precisely measured at the time of installation so as to determine at least relative positional relationships among the one or more anchor nodes. The measured relative positions of the anchor node 1 . . . anchor node N s may be mapped onto a diagram or 3D plan view of the indoor environment so as to associate with corresponding actual physical locations.

In an embodiment, the anchor node 1 . . . anchor node N 204 are permanently installed in respective locations across the indoor environment. In another embodiment, the anchor node 1 . . . anchor node N 204 may be detachably installed in respective locations across the indoor environment.

At step 504, the data acquisition module 206 receives the processed data from each tag of tag 1 . . . tag N 202, wherein each tag is configured to listen to heartbeat signals being shared between the anchor node 1 . . . anchor node N 204 and to process the heartbeat signals to derive the coordinates based on data received from the anchor node 1 . . . anchor node N 204.

The data acquisition module 206 stores the received processed data in a storage device that can include any suitable volatile or non-volatile storage media. The storage device may be configured to store instructions (for example, the computer-readable program code) that can implement various aspects of the present disclosure.

Finally at step 506, the tracking module 208 determines live positional information of the asset, based on data retrieved from the data acquisition module 206, wherein the tracking module 208 detects an indoor location of each tag of tag 1 . . . tag N 202 affixed on an asset using the UWB chipset and detects an outdoor location of each tag affixed on an asset using the GNSS chipset.

The tracking module 208 detects indoor and outdoor location of each tag by utilizing predictive positioning algorithms. For instance, the predictive positioning algorithms are mathematical or computational methods used to predict the position of the asset based on historical data, current position, and other relevant factors. These algorithms often utilize techniques like extrapolation, machine learning, or statistical analysis to estimate positions, making them valuable in various fields.

In an instance, each anchor node of the anchor node 1 . . . anchor node N 204 transmits random heartbeat signals and all the other neighboring anchor nodes and tags around the anchor node receives the transmitted heartbeat signals. The heartbeat signals contain timestamp of each anchor node, and its neighboring anchor nodes which receive these heartbeat signals respond back with a message containing respective timestamps. Accordingly, the tag 1 . . . tag N 202 that are in the range of anchor node 1 . . . anchor node N 204 receives time stamps and anchors' location (x, y, z) coordinates. Accordingly, each tag of the tag 1 . . . tag N 202 computes difference in distance between a pair of anchor nodes and then forms a hyperbola between the anchor node 1 . . . anchor node N 204 and its own position. Further, based on two or more pairs of hyperbola, each tag computes its intersection point to know its location.

The tracking module 208 thus determines live positional information of the asset based on data retrieved from the data acquisition module 206 that in turn receives information from the tag 202.

In an embodiment, the tracking module 208 also includes a GPS data processing unit to process GPS data received from the tags when the asset is in an outdoor environment, and an integration unit to seamlessly integrate positional data derived from UWB and GPS for continuous tracking of the asset across indoor and outdoor environments.

In some non-limiting embodiments, the GPS data processing unit can be referred to as a specialized electronic device designed to receive, process, and interpret signals from GPS satellites. The GPS data processing unit calculates precise position, velocity, and time information for a given location. The GPS data processing unit plays a crucial role in various applications, including navigation, transportation, surveying, mapping and the like.

The present disclosure is advantageous in that it combines both indoor and outdoor asset tracking into a single solution to offer a seamless transition between indoor and outdoor tracking. By providing the solution, the disclosure eliminates the costs that are involved in procuring separate hardware components, infrastructure, and maintenance.

More advantageously, the present disclosure, Geo RTLS, provides a framework to combine multiple technologies into a singular hardware thus providing a one-stop solution for tracking of assets in both indoor and outdoor environments.

In addition, the present disclosure is advantageous in that it uses a combination of anchors (fixed) and tags (movable) along with advanced positioning algorithms such as multi-lateration, dead reckoning etc. to accurately compute the position of the tags mounted onto any asset, vehicle, equipment, or person. The present disclosure offers a wide range of valuable features such as, but not limited to, real-time & accurate tracking and history playback of asset/employee movements, real-time management of indoor & outdoor inventory, productivity assessment based on customer specific KPIs, analytics and insights on resource & space utilization to identify bottlenecks & improve efficiency, and real-time alerts to improve safety of operations and protect assets/employees from potential threats/dangers etc.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A system for seamless tracking of an asset across an indoor environment and an outdoor environment, the system comprising:
a plurality of anchor nodes deployed across an indoor facility, wherein
each of the plurality of anchor nodes is configured to emit heartbeat signals,
the heartbeat signals from an anchor node of the plurality of anchor nodes are received by neighboring anchor nodes from the plurality of anchor nodes, and
the heartbeat signals comprise information pertaining to coordinates of corresponding anchor nodes of the plurality of anchor nodes;
a plurality of tags, each tag of the plurality of tags is affixed on an asset to be tracked, wherein each tag of the plurality of tags is configured to listen to the heartbeat signals being shared between the plurality of anchor nodes;
a data acquisition module configured to receive processed data from at least one of the plurality of tags; and
a tracking module configured to:
determine live positional information of the asset based on data retrieved from the data acquisition module;
detect an indoor location of a tag of the plurality of tags affixed on an asset using a UWB chipset; and
detect an outdoor location of the tag affixed on an asset using a Global Navigation Satellite System (GNSS) chipset.

2. The system as claimed in claim 1, wherein each tag of the plurality of tags is equipped with Global Positioning System (GPS) capabilities.

3. The system as claimed in claim 1, wherein each tag of the plurality of tags is configured to process the heartbeat signals to derive the coordinates based on data received from the plurality of anchor nodes.

4. The system as claimed in claim 1, wherein an asset is at least one of a fleet vehicle, an employee, an inventory, or an equipment.

5. The system as claimed in claim 1, wherein the tag is integrated with one or more sensors, each sensor of the one or more sensors comprises at least one of a location sensor, an accelerometer, a gyroscope, a temperature sensor, or a light sensor.

6. The system as claimed in claim 1, wherein
the plurality of tags and the plurality of anchor nodes are powered by rechargeable batteries, and
the tag or the anchor node is a wearable mounted onto the asset to monitor its movements in real-time.

7. The system as claimed in claim 1, wherein the system further includes a power management module configured to monitor and manage power levels of the plurality of tags and the plurality of anchor nodes.

8. The system as claimed in claim 1, wherein the tracking module is further configured to detect the indoor location and the outdoor location of the tag based on predictive positioning algorithms.

9. The system as claimed in claim 1, wherein the tracking module further comprises:
a GPS data processing unit configured to process GPS data received from the plurality of tags when the asset is in the outdoor environment; and
an integration unit configured to seamlessly integrate positional data derived from UWB and GPS for continuous tracking of the asset across the indoor environment and the outdoor environment.

10. The system as claimed in claim 1, wherein the tracking module further comprises a map interface module configured to visualize the positional information of the asset on a facility map.

11. A method for seamless tracking of an asset across an indoor environment and an outdoor environment, the asset being affixed with a tag and a plurality of anchor nodes being deployed across the indoor environment, the method comprising:
emitting heartbeat signals, by each anchor node of the plurality of anchor nodes, wherein
the heartbeat signals from an anchor node of the plurality of anchor nodes are received by neighboring anchor nodes of the plurality of anchor nodes, and
the heartbeat signals comprise information pertaining to coordinates of corresponding anchor nodes of the plurality of anchor nodes;
receiving processed data, by a data acquisition module from the tag, wherein the tag is configured to listen to the heartbeat signals being shared between the plurality of anchor nodes and to process the heartbeat signals to derive the coordinates based on data received from the plurality of anchor nodes; and
determining live positional information of the asset, using a tracking module, based on data retrieved from the data acquisition module, wherein the tracking module detects an indoor location of the tag affixed on an asset using a UWB chipset and detects an outdoor location of the tag affixed on an asset using a Global Navigation Satellite System (GNSS) chipset.

12. The method as claimed in claim 11, wherein the determining comprises:
detecting the indoor location of the tag based on the processed data from the tag and data associated with the UWB chipset of the tag, utilizing predictive positioning algorithms; and
detecting the outdoor location of the tag using the GNSS chipset of the tag, utilizing the predictive positioning algorithms.

13. The method as claimed in claim 12, wherein the determining further comprises processing GPS data received from the tag, using a GPS data processing unit, when the asset is in the outdoor environment.

14. The method as claimed in claim 11, further comprising visualizing the positional information of the asset on a facility map using a map interface module.

15. The method as claimed in claim 11, further comprising monitoring and managing power levels of the tag and the plurality of anchor nodes using a power management module.
